(19) United States
(12) Patent Application Publication
(10) Pub. No.: US 2015/0129804 A1
(43) Pub. Date: May 14, 2015

(54) Phosphor Material and Manufacturing Method Thereof

(71) Applicant: National Kaohsiung University of Applied Sciences, Kaohsiung (TW)

(72) Inventors: Su-Hua Yang, Kaohsiung (TW); Che-Min Lin, Kaohsiung (TW); Chia-Hung Yen, Kaohsiung (TW); Chih-Kai Yang, Kaohsiung (TW)

(21) Appl. No.: 14/525,435

(22) Filed: Oct. 28, 2014

(30) Foreign Application Priority Data
Nov. 13, 2013 (TW) 102141326
Nov. 13, 2013 (TW) 102141332

(51) Int. Cl. C09K 11/02; C09K 11/77

(52) U.S. Cl. CPC C09K 11/025; C09K 11/7795; C09K 11/7777
USPC 252/301.4 P; 427/157

(57) ABSTRACT

A phosphor material manufacturing method includes: prefabricating a LaPO₄:Tm⁺ solution or a LaPO₄:Eu⁺ solution in nitric acid; adding a carbon nano-sized material to the LaPO₄:Tm⁺ solution or the LaPO₄:Eu³⁺ solution for mixing to obtain a mixed solution precursors; precipitating the mixed solution and separating a precipitation substance from the mixed solution; drying and grinding the precipitation substance to obtain a powder material; the powder material with a predetermined temperature to form a sintered LaPO₄:Tm⁺ phosphor material or a sintered LaPO₄:Eu⁺ phosphor material. Advantageously, the sintered LaPO₄:Tm⁺ phosphor material or the sintered LaPO₄:Eu⁺ phosphor material is coated by the carbon nano-sized material for enhancing the efficiency of energy transfer and luminance of the phosphor material.

### BACKGROUND OF THE INVENTION

1. Field of the Invention

The present invention relates to a phosphor material and manufacturing method thereof. Particularly, the present invention relates to a blue (or near-blue) phosphor material and manufacturing method thereof. More particularly, the present invention relates to a reddish-orange phosphor material and manufacturing method thereof.

2. Description of the Related Art

U.S. Pat. No. 6,113,807, entitled “Phosphor and Method for Producing Same,” discloses a method for producing a phosphor made of luminous inorganic particles of a nanostructure which is capable of keeping a surface of the phosphor from being polluted by any by-product and controlling a particle diameter distribution of the phosphor as desired. A carbon material and an inorganic salt are mixed together to prepare a mixture, which is then heated, to thereby form an interlaminar compound. Then, the interlaminar compound is subject to a treatment using an eliminating agent, leading to production of luminous inorganic compound particles adhered to the carbon material.

However, the nano-structured luminous inorganic particles are only suitable for avoiding the phosphor being polluted by any by-product and controlling a particle diameter distribution of the phosphor. Hence, there is a need of enhancing the efficiency of energy transfer and luminance of the phosphors.

Another U.S. Patent Publication No. 20060255715, entitled “Carbon Nanotube Containing Phosphor,” discloses a phosphor for use in displays. The carbon nanotube containing phosphor is a mixture of phosphors and carbon nanotubes. The phosphor material is made from ZnS:Cu, Al green phosphor powders. The phosphor screen has the improvement of electrical and thermal conductivity.

However, the modification of the carbon nanotube containing phosphor is only suitable for manufacturing the Zn:S material. Still, there is a need of improving the enhancing the efficiency of energy transfer and luminance of the phosphors. The above-mentioned patent are incorporated herein by reference for purposes including, but not limited to, indicating the background of the present invention and illustrating the state of the art.

As is described in greater detail below, the present invention intends to provide a phosphor material and manufacturing method thereof. A LaPO₄:Tm⁺ or LaPO₄:Eu⁺ phosphor material is coated by a CNT or carbon nanowire material for surface modification. The CNT or carbon nanowire material is applied to modify surfaces of the LaPO₄:Tm⁺ or LaPO₄:Eu³⁺ phosphor material for enhancing the efficiency of energy transfer and luminance of the phosphors a in such a way as to mitigate and overcome the above problem.

### SUMMARY OF THE INVENTION

The primary objective of this invention is to provide a phosphor material and manufacturing method thereof. A LaPO₄:Tm⁺ phosphor material or a LaPO₄:Eu⁺ phosphor material is applied to produce a blue phosphor material or a reddish-orange phosphor material. Accordingly, the present invention is successful in producing the blue (or near-blue) phosphor or the reddish-orange phosphor.

Another objective of this invention is to provide a phosphor material and manufacturing method thereof, with a LaPO₄:Tm⁺ phosphor material or a LaPO₄:Eu⁺ phosphor material coated by a CNT or carbon nanowire material for surface modification. The CNT or carbon nanowire material is applied to modify surfaces of the LaPO₄:Tm⁺ phosphor material or the LaPO₄:Eu⁺ phosphor material for producing a blue or reddish-orange phosphor material. Accordingly, the phosphor material of the present invention is successful in enhancing the efficiency of energy transfer and luminance of the blue (or near-blue) phosphor or the reddish-orange phosphor.

The manufacturing method of the phosphor material in accordance with an aspect of the present invention includes:

preparing a LaPO₄:Tm⁺ solution or a LaPO₄:Eu⁺ solution in a nitric acid;

adding a CNT or carbon nanowire material to the LaPO₄:Tm⁺ solution or the LaPO₄:Eu⁺ solution for mixing to obtain a mixed solution and thus to cause a precursor;

co-precipitating the mixed solution a predetermined time and separating a precipitation substance from the mixed solution by centrifugal separation;

drying and grinding the precipitation substance to obtain a powder material; and

calcining (sintering) the powder material with a predetermined temperature to form a calcined LaPO₄:Tm⁺ phosphor material or a calcined

LaPO₄:Eu⁺ phosphor material, with the calcined LaPO₄:Tm⁺ phosphor material or the calcined LaPO₄:Eu⁺ phosphor material is coated by the CNT or carbon nanowire material for enhancing the efficiency of energy transfer and luminance of the phosphor material.

The phosphor material in accordance with an aspect of the present invention includes:

a LaPO₄:Tm⁺ phosphor material made from a LaPO₄:Tm⁺ solution;

a CNT or carbon nanowire material added to the LaPO₄:Tm⁺ solution for mixing to obtain a mixed solution and thus to cause a precursor; and

a precipitation substance separated from the mixed solution, with the precipitation substance comprising the LaPO₄:Tm⁺ phosphor material and the CNT or carbon nanowire material;

a LaPO₄:Tm⁺ powder material obtained from the precipitation substance by drying, grinding and calcining;

wherein the calcined LaPO₄:Tm⁺ phosphor material is coated by the CNT or carbon nanowire material for enhancing the efficiency of energy transfer and luminance of a blue or near-blue phosphor material.

The phosphor material in accordance with an aspect of the present invention includes:

a LaPO₄:Eu⁺ phosphor material made from a LaPO₄:Eu⁺ solution;

a CNT or carbon nanowire material added to the LaPO₄:Eu⁺ solution for mixing to obtain a mixed solution and thus to cause a precursor; and

a precipitation substance separated from the mixed solution, with the precipitation substance comprising the LaPO₄:Eu⁺ phosphor material and the CNT or carbon nanowire material;

a LaPO₄:Eu⁺ powder material obtained from the precipitation substance by drying, grinding and calcining;

wherein the calcined LaPO₄:Eu⁺ phosphor material is coated by the CNT or carbon nanowire material for enhancing the efficiency of energy transfer and luminance of a reddish-orange phosphor material.

In a separate aspect of the present invention, the LaPO₄:Tm⁺ phosphor material or the LaPO₄:Eu⁺ phosphor material is further doped by a common dopant material.

In a further separate aspect of the present invention, the common dopant material is selected from the group consisting of aluminum (Al), europium (Eu) and combination thereof.

In yet a further separate aspect of the present invention, the phosphate material is selected from the group consisting of (NH₄)₂PO₄, H₃PO₄, Na₅P₃O₁₀ and mixtures thereof.

In yet a further separate aspect of the present invention, the mixed solution of the LaPO₄:Tm⁺ phosphor material has a CNT or carbon nanowire concentration ranging between 0.75 wt % and 1.0 wt %, 1.0 wt % and 1.25 wt %, 1.25 wt % and 1.5 wt %, or 0.75 wt % and 1.5 wt %.

In yet a further separate aspect of the present invention, the LaPO₄:Tm³⁺ phosphor material has a Tm⁺ doping concentration ranging between 1.0 mole % and 3.0 mole %, 3.0 mole % and 5.0 mole %, 5.0 mole % and 6.0 mole %, or 1.0 mole % and 6.0 mole %.

In yet a further separate aspect of the present invention, the LaPO₄:Tm³⁺ phosphor material or the LaPO₄:Eu⁺ phosphor material is further modified by a surfactant.

In yet a further separate aspect of the present invention, the surfactant is a surface active agent or a dispersant.

In yet a further separate aspect of the present invention, the mixed solution of the LaPO₄:Eu⁺ phosphor material has a CNT or carbon nanowire concentration ranging between 0.5 wt % and 0.75 wt %, 0.75 wt % and 1.0 wt %, 1.0 wt % and 1.25 wt %, or 0.5 wt % and 1.25 wt %.

In yet a further separate aspect of the present invention, the LaPO₄:Eu³⁺ phosphor material has a Eu⁺ doping concentration ranging between 3.0 mole % and 5.0 mole %, 5.0 mole % and 7.0 mole %, 7.0 mole % and 9.0 mole %, or 3.0 mole % and 9.0 mole %.

In yet a further separate aspect of the present invention, mixing the LaPO₄:Tm⁺ solution with the LaPO₄:Eu⁺ solution with a predetermined ratio to produce a LaPO₄:Tm⁺ and LaPO₄:Eu⁺ mixed powder material.

In yet a further separate aspect of the present invention, the LaPO₄:Tm³⁺ and LaPO₄:Eu⁺ mixed powder material includes a predetermined ratio of LaPO₄:Tm⁺ concentration and LaPO₄:Eu⁺ concentration.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a flow chart of a manufacturing method of a LaPO₄:Tm³⁺ phosphor material in accordance with a first preferred embodiment of the present invention.

FIG. 2 is a chart illustrating photoluminescence intensities in relation to wavelengths of the LaPO₄:Tm⁺ phosphor materials coated with various concentrations of a CNT material in accordance with the first preferred embodiment of the present invention.

FIG. 3 is an image of the uncoated and coated LaPO₄:Tm⁺ phosphor materials in accordance with the first preferred embodiment of the present invention.

FIG. 4 is a chart illustrating cathodoluminescence intensities in relation to wavelengths of the LaPO₄:Tm⁺ phosphor materials coated with various concentrations of the CNT material in accordance with the first preferred embodiment of the present invention.

FIG. 5 is a chart illustrating current in relation to voltages of the uncoated and coated LaPO₄:Tm⁺ phosphor materials in accordance with the first preferred embodiment of the present invention.

FIG. 6 is a chart illustrating photoluminescence intensities in relation to wavelengths of the LaPO₄:Tm⁺ phosphor materials doped with various doping concentrations of aluminum in accordance with the first preferred embodiment of the present invention.

FIG. 7 is a chart illustrating photoluminescence intensities in relation to wavelengths of the LaPO₄:Tm⁺ phosphor materials doped with various doping concentrations of europium in accordance with the first preferred embodiment of the present invention.

FIG. 8 is a flow chart of a manufacturing method of a LaPO₄:Eu³⁺ phosphor material in accordance with a second preferred embodiment of the present invention.

FIG. 9 is a chart illustrating photoluminescence excitation intensities in relation to wavelengths of the La₁₋ₓPO₄:xEu⁺ phosphor materials doped with various doping concentrations of europium in accordance with the second preferred embodiment of the present invention.

FIG. 10 is a chart illustrating photoluminescence intensities in relation to wavelengths of the La₁₋ₓPO₄:Eu⁺ phosphor materials doped with various doping concentrations of europium in accordance with the second preferred embodiment of the present invention.

FIGS. 11(a)-11(c) are images of CIE coordinates of the LaPO₄:Eu³⁺ phosphor material made from various phosphate materials in accordance with the second preferred embodiment of the present invention.

FIG. 12 is a chart illustrating photoluminescence intensities in relation to wavelengths of the LaPO₄:Eu⁺ phosphor materials coated with various concentrations of a CNT material in accordance with the second preferred embodiment of the present invention.

FIG. 13 is a chart illustrating cathodoluminescence intensities in relation to wavelengths of the LaPO₄:Eu⁺ phosphor materials coated with various concentrations of the CNT material in accordance with the second preferred embodiment of the present invention.

FIG. 14 is an image of cathodoluminescence emitted from the reddish-orange phosphor material in accordance with the second preferred embodiment of the present invention.

FIG. 15 is an image of cathodoluminescence emitted from the blue phosphor material in accordance with the preferred embodiment of the present invention.

### DETAILED DESCRIPTION OF THE INVENTION

It is noted that a phosphor material and manufacturing method thereof in accordance with the preferred embodiment of the present invention is suitable for usage of various dopant materials, calcining temperatures (e.g. 1000° C. to 1300° C.), or calcining time periods (e.g. 0.5 hr to 3 hrs), which are not limitative of the present invention.

The phosphor material and manufacturing method thereof in accordance with the preferred embodiment of the present invention is applied to modify a LaPO₄:Tm⁺ (blue or near-blue) phosphor material, a LaPO₄:Eu³⁺ (reddish-orange) phosphor material and a mixture thereof which are applicable to illuminant materials of various illumination devices and display devices (e.g. field emission display, FED).

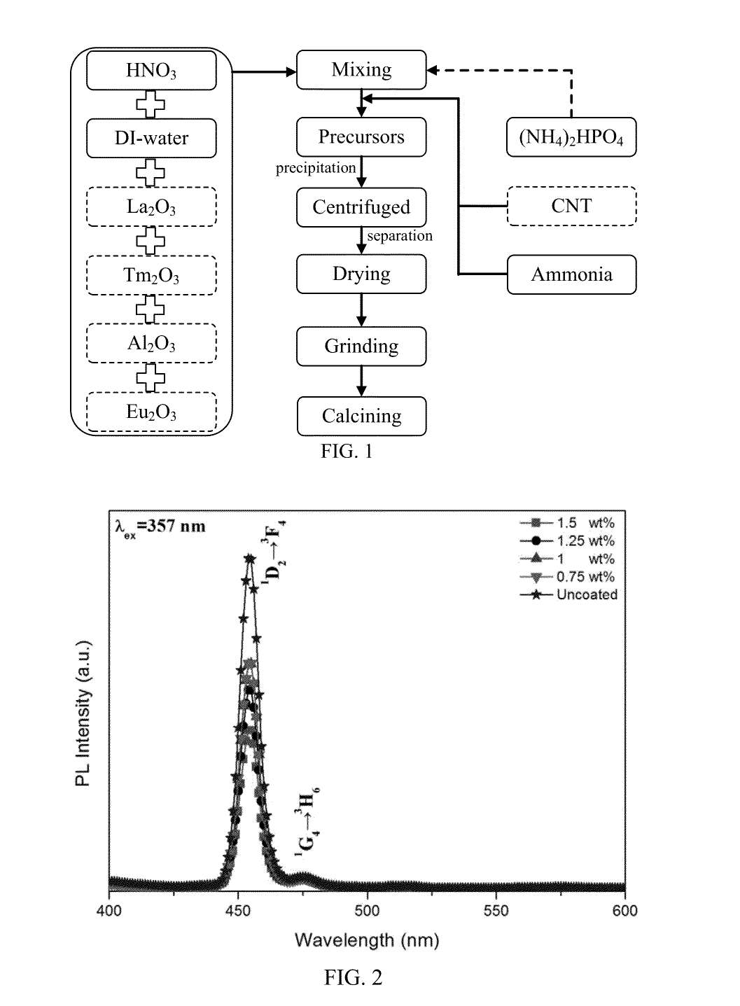

Referring initially to FIG. 1, the manufacturing method of the LaPO₄:Tm⁺ phosphor material of the first preferred embodiment of the present invention includes the step of: providing a LaPO₄:Tm⁺ phosphor material and a carbon nano-sized (CNT or carbon nanowire) material. The LaPO₄:Tm⁺ phosphor material has a Tm⁺ doping concentration ranging between 1.0 mole % and 3.0 mole %, 3.0 mole % and 5.0 mole %, 5.0 mole % and 6.0 mole %, or 1.0 mole % and 6.0 mole %. With continued reference to FIG. 1, the manufacturing method of the

LaPO₄:Tm⁺ phosphor material of the first preferred embodiment of the present invention further includes the step of: preparing a LaPO₄:Tm³⁺ solution in a nitric acid (HNO₃) by mixing the LaPO₄:Tm⁺ phosphor material with DI (deionized) water. In a preferred embodiment, Tm₂O₃ and La₂O₃ are dissolved in nitric acid and DI water to form the LaPO₄:Tm³⁺ solution to which a liquid of (NH₄)₂PO₄ is further added slowly and mixed.

Still referring to FIG. 1, the manufacturing method of the LaPO₄:Tm³⁺ phosphor material of the first preferred embodiment of the present invention further includes the step of: adding the carbon nano-sized (CNT or carbon nanowire) material to the LaPO₄:Tm⁺ solution for mixing to obtain a mixed solution and thus to cause a precursor. In a preferred embodiment, a predetermined amount of NH₄OH and the carbon nano-sized (CNT or carbon nanowire) material are added to the LaPO₄:Tm⁺ solution and then are stirred to mix them in the mixed solution which has a pH value of 8-9.

In a preferred embodiment, the carbon nano-sized material is a CNT material, a carbon nanowire material or mixture thereof. The mixture of the CNT and carbon nanowire material has a predetermined ratio. In preparing the mixed solution, the CNT material and the carbon nanowire material are added in sequence, and vice versa. In an alternative, the CNT material and the carbon nanowire material are added at the same time.

Still referring to FIG. 1, the manufacturing method of the LaPO₄:Tm³⁺ phosphor material of the first preferred embodiment of the present invention further includes the step of: co-precipitating the mixed solution a predetermined time and separating a precipitation substance from the mixed solution by centrifugal separation or the like. Furthermore, the separated precipitation substance is washed by DI water and ethanol (i.e. alcohol) for removing residues.

Still referring to FIG. 1, by way of example, the manufacturing method of the LaPO₄:Tm⁺ phosphor material of the first preferred embodiment of the present invention further includes the step of: drying and grinding the precipitation substance to obtain a LaPO₄:Tm⁺ powder material. In a preferred embodiment, the precipitation substance is selectively dried in 90° C. heat wind a predetermined time and then the different precipitation substances (e.g. precipitation substances of the LaPO₄:Tm⁺ solution and the LaPO₄:Eu⁺ solution) are ground in a ball mill machine for mixing.

Still referring to FIG. 1, the manufacturing method of the LaPO₄:Tm³⁺ phosphor material of the first preferred embodiment of the present invention further includes the step of: calcining the powder material with a predetermined temperature to form a calcined LaPO₄:Tm⁺ phosphor material. In a preferred embodiment, the powder material is calcined in 1000° C. to 1300° C. for 0.5 hr to 3 hrs. Advantageously, the calcined LaPO₄:Tm⁺ phosphor material is coated by the CNT or carbon nanowire material for enhancing the efficiency of energy transfer and luminance of a blue or near-blue phosphor material. In a preferred embodiment, the different powder materials (e.g. LaPO₄:Tm⁺ and LaPO₄:Eu⁺ powder materials) are added and calcined together.

Turning now to FIG. 2, the photoluminescence (PL) intensities in relation to wavelengths of the LaPO₄:Tm⁺ phosphor materials coated with four predetermined concentrations of a CNT material of the first preferred embodiment of the present invention and the uncoated LaPO₄:Tm³⁺ phosphor material is shown. The uncoated and coated LaPO₄:Tm⁺ phosphor materials are selectively excited by an exciting light having a wavelength of 357 nm. Compared with the uncoated LaPO₄:Tm⁺ phosphor material, the PL intensities emitted from the coated LaPO₄:Tm⁺ phosphor materials decrease due to increasing the concentrations of the CNT material coated on the LaPO₄:Tm⁺ phosphor materials. In a preferred embodiment, the LaPO₄:Tm⁺ phosphor material has the CNT or carbon nanowire concentration ranging between 0.5 wt % and 0.75 wt %, 0.75 wt % and 1.0 wt %, 1.0 wt % and 1.25 wt %, or 0.5 wt % and 1.25 wt %. Advantageously, the LaPO₄:Tm⁺ phosphor material is suitable for producing the blue or near-blue phosphor material.

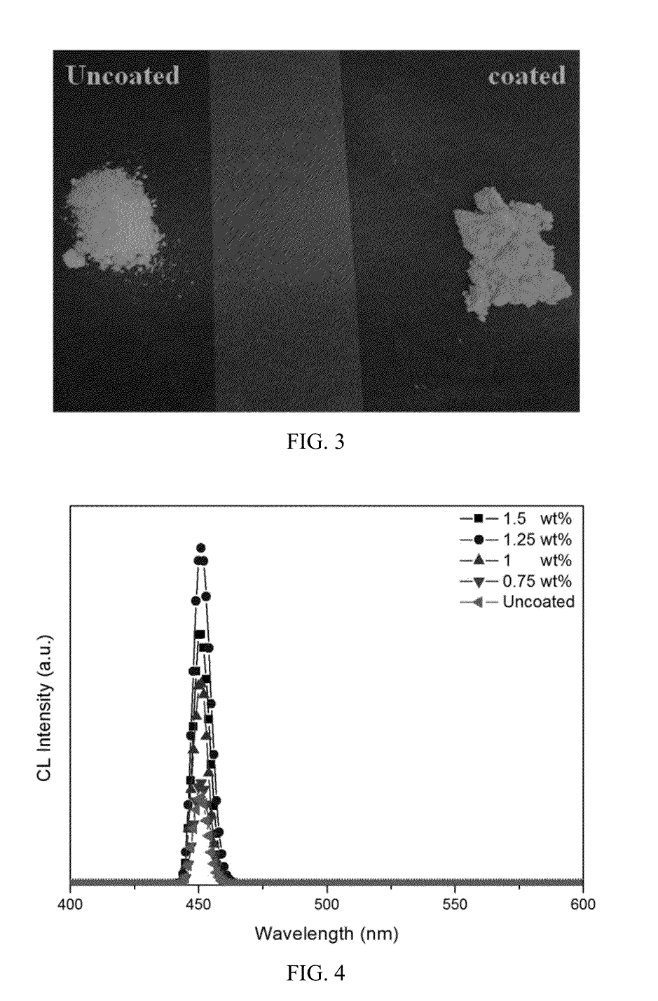

Turning now to FIG. 3, the appearances of the uncoated LaPO₄:Tm³⁺ phosphor material (left side in FIG. 3) and the coated LaPO₄:Tm⁺ phosphor material of the first preferred embodiment of the present invention (right side in FIG. 3) is compared. The color of the coated LaPO₄:Tm⁺ phosphor material is dark black which is different from that of the uncoated LaPO₄:Tm⁺ phosphor material.

Turning now to FIG. 4, the cathodoluminescence (CL) intensities in relation to wavelengths of the LaPO₄:Tm⁺ phosphor materials coated with four concentrations of the CNT material of the first preferred embodiment of the present invention and the uncoated LaPO₄:Tm⁺ phosphor material is shown. The concentrations of the CNT material coated on the LaPO₄:Tm³⁺ phosphor material is 0.75 wt %, 1.0 wt %, 1.25 wt % and 1.5 wt %. Compared with the uncoated LaPO₄:Tm⁺ phosphor material, the CL intensity emitted from the LaPO₄:Tm⁺ phosphor material coated with the 1.25 wt % CNT material is the strongest, as best shown in the topmost waveform in FIG. 4.

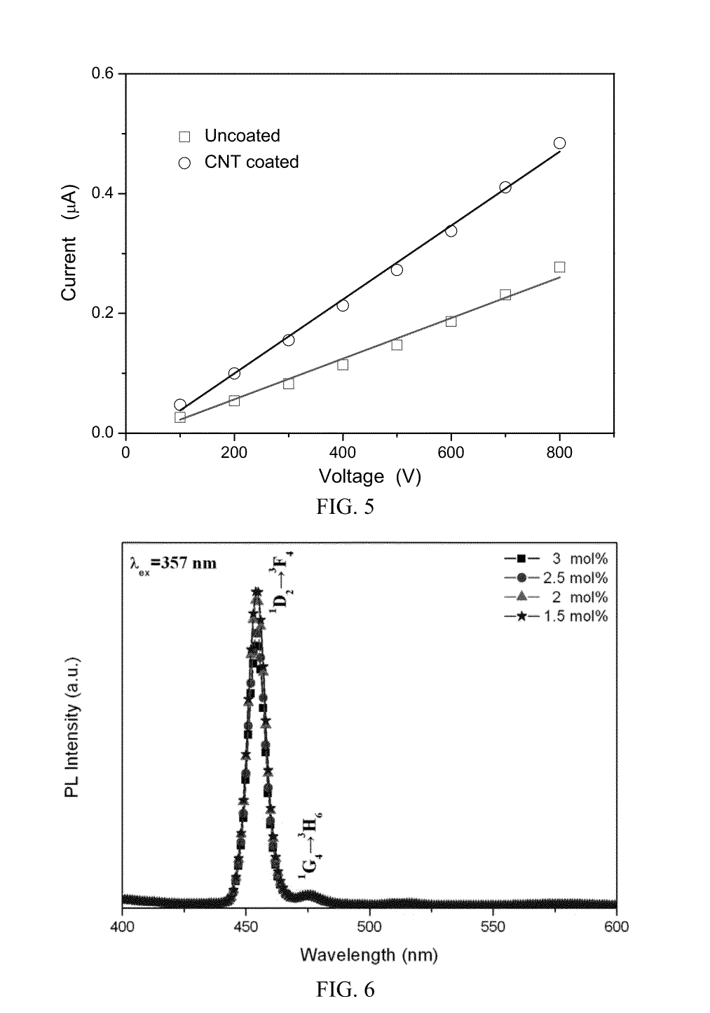

Turning now to FIG. 5, the current in relation to voltages of the uncoated LaPO₄:Tm⁺ phosphor material (shown in squares of the lower portion in FIG. 5) and the coated LaPO₄:Tm⁺ phosphor material of the first preferred embodiment of the present invention (shown in circles of the upper portion in FIG. 5) is shown. The CNT material coated on the LaPO₄:Tm⁺ phosphor material has a concentration of 1.5 wt %. Compared with the uncoated LaPO₄:Tm⁺ phosphor material, the current of the coated LaPO₄:Tm⁺ phosphor material to the voltages is obviously higher than that of the uncoated LaPO₄:Tm⁺ phosphor material when the voltage increases.

Referring back to FIG. 1, the LaPO₄:Tm⁺ phosphor material or the LaPO₄:Eu⁺ phosphor material is further doped by a common dopant material, as best shown in left side of FIG. 1. The common dopant material is selected from the group consisting of aluminum (Al), europium (Eu) and combination thereof. In a preferred embodiment, Al₂O₃ or Eu₂O₃ is dissolved in nitric acid and further mixed with DI water for preparing the common dopant material.

Turning now to FIG. 6, the photoluminescence intensities in relation to wavelengths of the LaPO₄:Tm⁺ phosphor materials doped with four doping concentrations of aluminum of the first preferred embodiment of the present invention are shown. The coated LaPO₄:Tm⁺ phosphor materials doped with aluminum are selectively excited by an exciting light having a wavelength of 357 nm. The doping concentrations of aluminum (Al³⁺) on the LaPO₄:Tm⁺ phosphor material are 1.5 mole %, 2.0 mole %, 2.5 mole % and 3.0 mole %. It is found that the PL intensities emitted from the coated LaPO₄:Tm⁺ phosphor material will increase while the doping concentrations of aluminum (Al³⁺) increase. In a preferred embodiment, the doping concentration of aluminum (Al³⁺) ranges between 1.5 mole % and 2.0 mole %, 2.0 mole % and 2.5 mole %, 2.5 mole % and 3.0 mole %, or 1.5 mole % and 3.0 mole %. Advantageously, the LaPO₄:Tm⁺ phosphor material doped with aluminum is suitable for producing the blue or near-blue phosphor material.

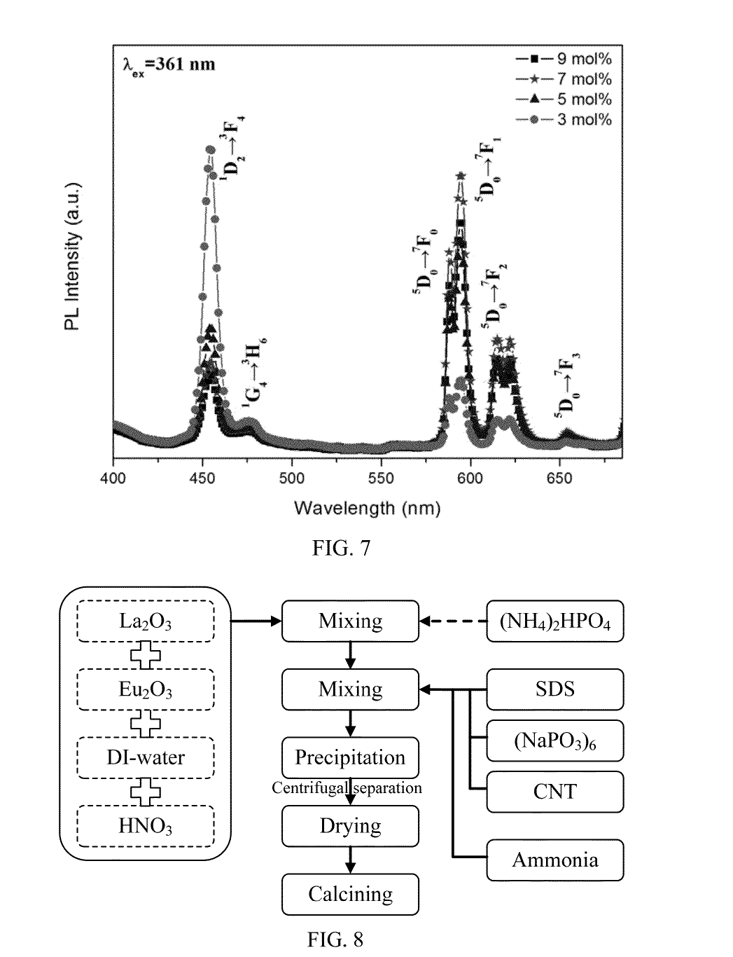

Turning now to FIG. 7, the photoluminescence intensities in relation to wavelengths of the LaPO₄:Tm⁺ phosphor materials doped with four doping concentrations of europium of the first preferred embodiment of the present invention are shown. The LaPO₄:Tm⁺ phosphor materials doped with europium are selectively excited by an exciting light having a wavelength of 361 nm. The doping concentrations of europium (Eu³⁺) on the LaPO₄:Tm³⁺ phosphor materials are 3 mole %, 5 mole %, 7 mole % and 9 mole %. In a preferred embodiment, the doping concentration of europium (Eu³⁺) ranges between 3 mole % and 5 mole %, 5 mole % and 7 mole %, 7 mole % and 9 mole %, or 3 mole % and 9 mole %. Advantageously, the LaPO₄:Tm³⁺ phosphor material doped with europium is suitable for producing the white or near-white phosphor material.

With continued reference to FIG. 7, it is found that increasing the doping concentrations of europium (Eu³⁺) on the LaPO₄:Tm⁺ phosphor material with a fixed concentration of thulium (Tm³⁺) has a gradual decrease of PL intensity peak at 454 nm and a gradual increase of PL intensity peak at 594 nm where appears reddish-orange light. Furthermore, it will be found that the white light emitted from the LaPO₄:Tm⁺ phosphor material doped with the 7 mole % doping concentration of europium (Eu³⁺) will be the strongest.

Turning now to FIG. 8, the manufacturing method of the LaPO₄:Eu³⁺ phosphor material of the second preferred embodiment of the present invention includes the step of: providing a LaPO₄:Eu⁺ phosphor material and a carbon nano-sized (CNT or carbon nanowire) material. The LaPO₄:Eu⁺ phosphor material has a Eu⁺ doping concentration ranging between 3.0 mole % and 5.0 mole %, 5.0 mole % and 7.0 mole %, 7.0 mole % and 9.0 mole %, or 3.0 mole % and 9.0 mole %.

With continued reference to FIG. 8, the LaPO₄:Eu⁺ phosphor material includes a La₂O₃ material, a Eu₂O₃ material and a phosphate material which are mixed in a solution. The phosphate material is selected from the group consisting of (NH₄)₂PO₄, H₃PO₄, Na₅P₃O₁₀ and mixtures thereof.

With continued reference to FIG. 8, the manufacturing method of the LaPO₄:Eu⁺ phosphor material of the second preferred embodiment of the present invention further includes the step of: preparing a LaPO₄:Eu³⁺ solution in a nitric acid (e.g. 65% HNO₃) by mixing the LaPO₄:Eu³⁺ phosphor material with DI (deionized) water. In a preferred embodiment, La₂O₃ and Eu₂O₃ are dissolved in nitric acid and DI water to form the LaPO₄:Eu⁺ solution to which a liquid of (NH₄)₂PO₄ is further added slowly and mixed.

Still referring to FIG. 8, the manufacturing method of the LaPO₄:Eu³⁺ phosphor material of the second preferred embodiment of the present invention further includes the step of: adding the carbon nano-sized (CNT or carbon nanowire) material to the LaPO₄:Tm⁺ solution for mixing to obtain a mixed solution and thus to cause a precursor. In a preferred embodiment, a predetermined amount of NH₄OH and the carbon nano-sized (CNT or carbon nanowire) material are added to the LaPO₄:Eu⁺ solution and then are stirred to mix them in the mixed solution.

In a preferred embodiment, the carbon nano-sized material is a CNT material, a carbon nanowire material or mixture thereof. The mixture of the CNT and carbon nanowire material has a predetermined ratio. In preparing the mixed solution, the CNT material and the carbon nanowire material are added in sequence, and vice versa. In an alternative, the CNT material and the carbon nanowire material are added at the same time.

Still referring to FIG. 8, by way of example, in a preferred embodiment, the LaPO₄:Eu⁺ phosphor material is further modified by a surfactant which is a surface active agent (e.g. sodium dodecyl sulfate, SDS) or a dispersant (e.g. NaPO₃)₆. The surfactant is applied to modify the surfaces of the LaPO₄:Eu⁺ phosphor material such that particles of the phosphor material and the carbon nano-sized material have a high degree of surface activity, compatibility and stability. The surface active agent has a concentration ranging between 2.0 mole % and 3.0 mole %, 3.0 mole % and 4.0 mole % or 2.0 mole % and 4.0 mole %. Also, the dispersant has a concentration ranging between 0.25 mole % and 0.5 mole %, 0.5 mole % and 1.0 mole %, 1.0 mole % and 1.5 mole %, or 0.25 mole % and 1.5 mole %.

Still referring to FIG. 8, the manufacturing method of the LaPO₄:Eu³⁺ phosphor material of the second preferred embodiment of the present invention further includes the step of: co-precipitating the mixed solution a predetermined time and separating a precipitation substance from the mixed solution by centrifugal separation or the like. Furthermore, the separated precipitation substance is washed by DI water and ethanol (i.e. alcohol) for removing residues.

Still referring to FIG. 8, by way of example, the manufacturing method of the LaPO₄:Eu⁺ phosphor material of the second preferred embodiment of the present invention further includes the step of drying and grinding the precipitation substance to obtain a LaPO₄:Tm⁺ powder material. In a preferred embodiment, the precipitation substance is selectively dried in 80° C. heat wind a predetermined time and then the different precipitation substances (e.g. precipitation substances of the LaPO₄:Tm⁺ solution and the LaPO₄:Eu⁺ solution) are ground in a ball mill machine for mixing.

Still referring to FIG. 8, the manufacturing method of the LaPO₄:Eu³⁺ phosphor material of the second preferred embodiment of the present invention further includes the step of: calcining the powder material with a predetermined temperature to form a calcined LaPO₄:Eu⁺ phosphor material. In a preferred embodiment, the powder material is calcined in 1000° C. to 1300° C. for 0.5 hr to 3 hrs. Advantageously, the calcined LaPO₄:Eu³⁺ phosphor material is coated by the CNT or carbon nanowire material for enhancing the efficiency of energy transfer and luminance of a reddish-orange phosphor material. In a preferred embodiment, the different powder materials (e.g. LaPO₄:Tm⁺ and LaPO₄:Eu⁺ powder materials) are added and calcined together.

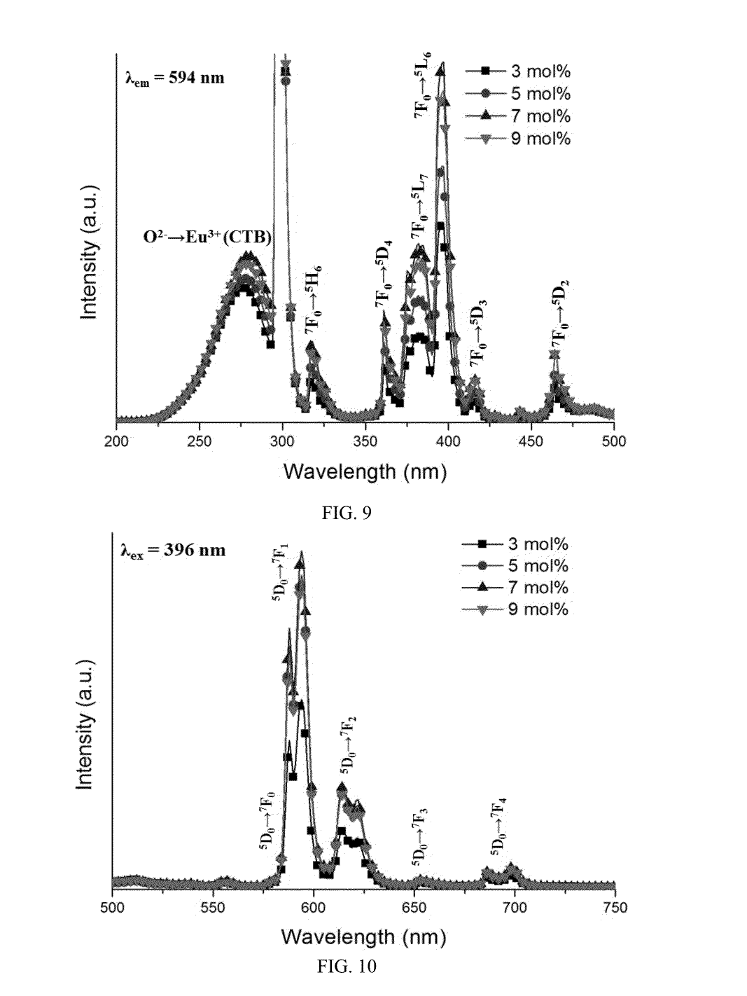

Turning now to FIG. 9, the photoluminescence excitation (PLE) intensities in relation to wavelengths of the LaPO₄:Eu⁺ phosphor materials doped with four doping concentrations of europium of the second preferred embodiment of the present invention are shown. The coated La₁₋ₓPO₄:xEu³⁺ phosphor materials are selectively excited by an exciting light having a wavelength of 594 nm. The doping concentrations of europium (Eu³⁺) on the La₁₋ₓPO₄:xEu⁺ phosphor materials are 3 mole %, 5 mole %, 7 mole % and 9 mole %. Advantageously, it is found that the La₁₋ₓPO₄:Eu⁺ phosphor material doped with 7 mole % europium (Eu³⁺) calcined in 1200° C. for 2 hrs have a good absorbency of exciting energy for emitting a good reddish-orange light at 594 nm peak (⁵D₀→⁷F₁).

Turning now to FIG. 10, the photoluminescence (PL) intensities in relation to wavelengths of the LaPO₄:Eu⁺ phosphor materials doped with four doping concentrations of europium of the second preferred embodiment of the present invention are shown. The coated La₁₋ₓPO₄:xEu⁺ phosphor materials are selectively excited by an exciting light having a wavelength of 396 nm. The doping concentrations of europium (Eu³⁺) on the La₁₋ₓPO₄:xEu⁺ phosphor materials are 3 mole %, 5 mole %, 7 mole % and 9 mole %. Advantageously, it is found that the La₁₋ₓPO₄:Eu⁺ phosphor material doped with 7 mole % europium (Eu^{3±}) calcined in 1200° C. for 2 hrs have a strongest emission intensity of a peak located at 594 nm.

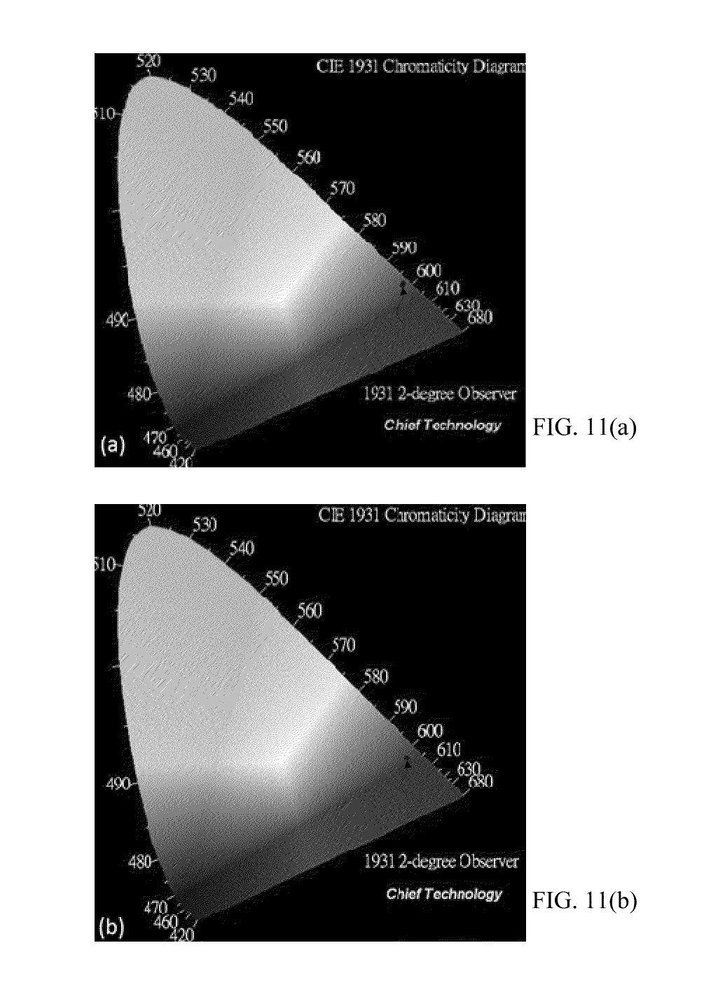

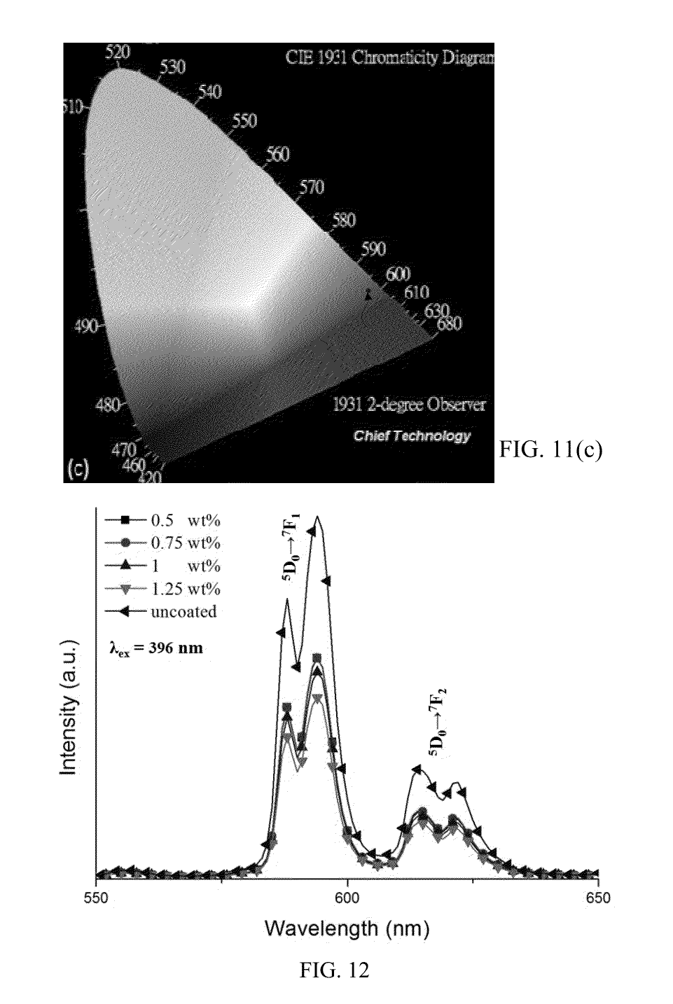

Turning now to FIGS. 11(a)-11(c), three CIE coordinates of the LaPO₄:Eu⁺ phosphor material made from three phosphate materials of the second preferred embodiment of the present invention are shown. In a preferred embodiment, the phosphate material is selected from the group consisting of (NH₄)₂PO₄, H₃PO₄, Na₅P₃O₁₀ and mixtures thereof. The first CIE coordinates of the LaPO₄:Eu⁺ phosphor material made from (NH₄)₂PO₄ (0.615, 0.374), as shown in arrow of FIG. 11(a). The second CIE coordinates of the LaPO₄:Eu⁺ phosphor material made from H₃PO₄ (0.621, 0.349), as shown in arrow of FIG. 11(b). The third CIE coordinates of the LaPO₄:Eu³⁺ phosphor material made from Na₅P₃O₁₀ (0.605, 0.371), as shown in arrow of FIG. 11(c).

Turning now to FIG. 12, the photoluminescence (PL) intensities in relation to wavelengths of the coated LaPO₄:Eu⁺ phosphor materials with various concentrations of a CNT material of the second preferred embodiment of the present invention and the uncoated LaPO₄:Eu⁺ phosphor material is shown. The uncoated and coated LaPO₄:Eu⁺ phosphor materials are selectively excited by an exciting light having a wavelength of 396 nm. Compared with the uncoated LaPO₄:Eu⁺ phosphor material, the PL intensities emitted from the coated LaPO₄:Eu⁺ phosphor materials decrease due to increasing the concentrations of the CNT material coated on the LaPO₄:Eu⁺ phosphor materials. It is found that the PL intensities emitted from the LaPO₄:Eu⁺ phosphor materials have a strongest emission intensity of a peak located at 594 nm. In a preferred embodiment, the LaPO₄:Eu³⁺ phosphor material has the CNT or carbon nanowire concentration ranging between 0.5 wt % and 0.75 wt %, 0.75 wt % and 1.0 wt %, 1.0 wt % and 1.25 wt %, or 0.5 wt % and 1.25 wt %.

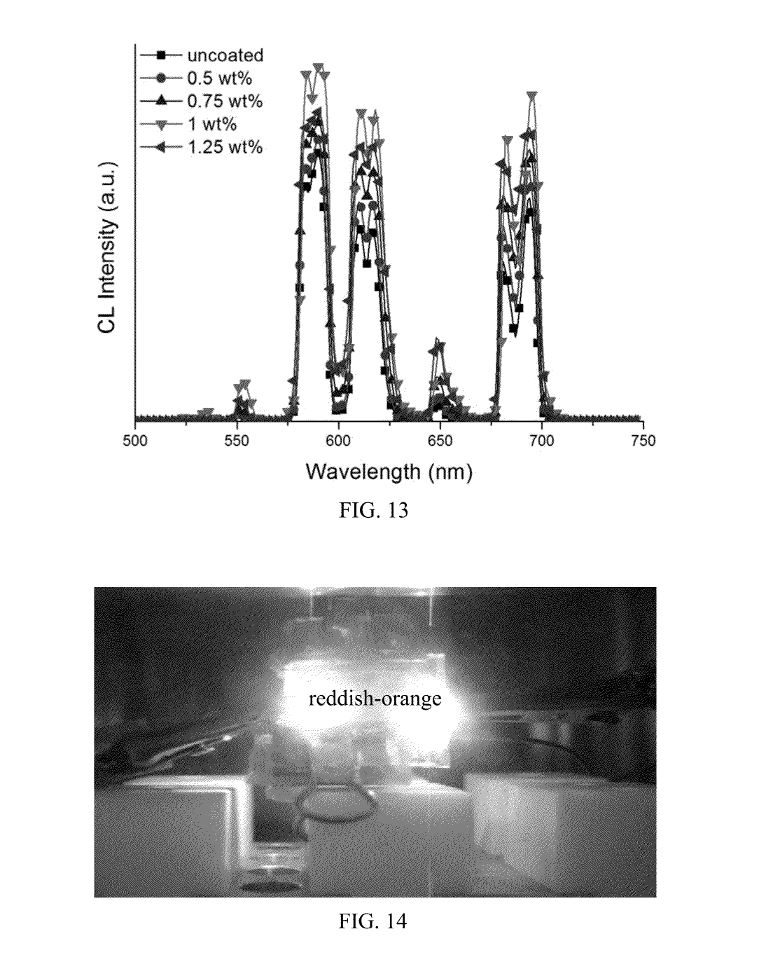

Turning now to FIG. 13, the cathodoluminescence (CL) intensities in relation to wavelengths of the LaPO₄:Eu⁺ phosphor materials coated with four concentrations of the CNT material of the second preferred embodiment of the present invention and the uncoated LaPO₄:Eu⁺ phosphor material is shown. The concentrations of the CNT material coated on the LaPO₄:Tm⁺ phosphor material is 0.75 wt %, 1.0 wt %, 1.25 wt % and 1.5 wt %. Compared with the uncoated LaPO₄:Eu⁺ phosphor material, the CL intensity emitted from the LaPO₄:Eu⁺ phosphor material coated with the 1.0 wt % CNT material is the strongest, as best shown in inverted-triangles of FIG. 13.

Turning now to FIG. 14, the cathodoluminescence (CL) emitted from the reddish-orange phosphor material of the second preferred embodiment of the present invention is shown. In a preferred embodiment, the manufacturing method of the reddish-orange phosphor material adopts a co-precipitation method or a solid-state method.

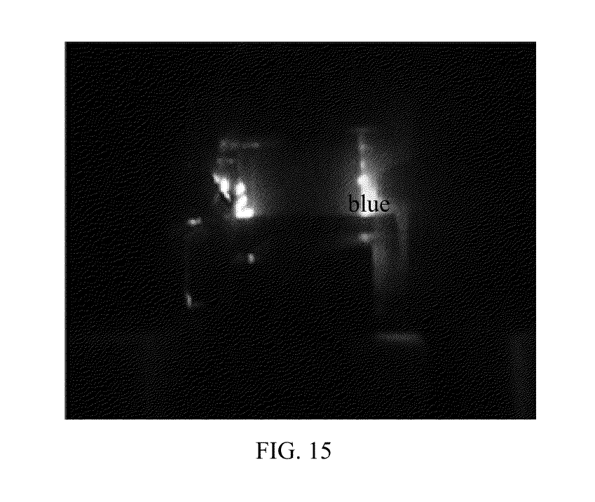

Turning now to FIG. 15, the cathodoluminescence (CL) emitted from the blue phosphor material of the preferred embodiment of the present invention is shown. In a preferred embodiment, the LaPO₄:Tm⁺ solution and the LaPO₄:Eu⁺ solution are mixed with a predetermined ratio to produce a LaPO₄:Tm⁺ and LaPO₄:Eu⁺ mixed powder material by the methods, as best shown in FIGS. 1 and 8. Accordingly, the LaPO₄:Tm⁺ and LaPO₄:Eu⁺ mixed powder material includes a predetermined ratio of LaPO₄:Tm⁺ concentration and LaPO₄:Eu⁺ concentration.

Although the invention has been described in detail with reference to its presently preferred embodiment, it will be understood by one of ordinary skills in the art that various modifications can be made without departing from the spirit and the scope of the invention, as set forth in the appended claims.

What is claimed is:

1. A manufacturing method of a phosphor material, comprising:
preparing a LaPO₄:Tm⁺ solution or a LaPO₄:Eu⁺ solution in a nitric acid;
adding a carbon nano-sized material to the LaPO₄:Tm⁺ solution or the LaPO₄:Eu⁺ solution for mixing to obtain a mixed solution and thus to cause a precursor;
precipitating the mixed solution a predetermined time and separating a precipitation substance from the mixed solution by centrifugal separation;
drying and grinding the precipitation substance to obtain a powder material; and
sintering the powder material with a predetermined temperature to form a sintered LaPO₄:Tm⁺ phosphor material or a sintered LaPO₄:Eu⁺ phosphor material, with the sintered LaPO₄:Tm⁺ phosphor material or the sintered LaPO₄:Eu⁺ phosphor material is coated by the carbon nano-sized material.

2. The manufacturing method of the phosphor material as defined in claim 1, wherein the LaPO₄:Tm⁺ phosphor material or the LaPO₄:Eu³⁺ phosphor material is further doped by a common dopant material.

3. The manufacturing method of the phosphor material as defined in claim 1, wherein the phosphate material is selected from the group consisting of (NH₄)₂PO₄, H₃PO₄, Na₅P₃O₁₀ and mixtures thereof.

4. The manufacturing method of the phosphor material as defined in claim 1, wherein the LaPO₄:Tm⁺ phosphor material or the LaPO₄:Eu³⁺ phosphor material is further modified by a surfactant.

5. The manufacturing method of the phosphor material as defined in claim 5, wherein the surfactant is a surface active agent or a dispersant.

6. The manufacturing method of the phosphor material as defined in claim 1, wherein mixing the LaPO₄:Tm⁺ solution with the LaPO₄:Eu³⁺ solution with a predetermined ratio to produce a LaPO₄:Tm⁺ and LaPO₄:Eu⁺ mixed powder material.

7. A phosphor material, comprising:
a LaPO₄:Tm⁺ phosphor material made from a LaPO₄:Tm⁺ solution;
a carbon nano-sized material added to the LaPO₄:Tm⁺ solution for mixing to obtain a mixed solution and thus to cause a precursor; and
a precipitation substance separated from the mixed solution, with the precipitation substance comprising the LaPO₄:Tm⁺ phosphor material and the carbon nano-sized material;
a LaPO₄:Tm⁺ powder material obtained from the precipitation substance by drying, grinding and sintering;
wherein the sintered LaPO₄:Tm⁺ phosphor material is coated by the carbon nano-sized material for forming a blue or near-blue phosphor material.

8. The phosphor material as defined in claim 7, wherein the mixed solution of the LaPO₄:Tm⁺ phosphor material has a carbon nano-sized material concentration ranging between 0.75 wt % and 1.0 wt %, 1.0 wt % and 1.25 wt %, 1.25 wt % and 1.5 wt %, or 0.75 wt % and 1.5 wt %.

9. The phosphor material as defined in claim 7, wherein the LaPO₄:Tm⁺ phosphor material has a Tm⁺ doping concentration ranging between 1.0 mole % and 3.0 mole %, 3.0 mole % and 5.0 mole %, 5.0 mole % and 6.0 mole %, or 1.0 mole % and 6.0 mole %.

10. The phosphor material as defined in claim 7, wherein the LaPO₄:Tm⁺ phosphor material is further doped by a common dopant material.

11. The phosphor material as defined in claim 10, wherein the common dopant material is selected from the group consisting of aluminum, europium and combination thereof.

12. The phosphor material as defined in claim 7, wherein the LaPO₄:Tm⁺ phosphor material is further modified by a surfactant.

13. The. phosphor material as defined in claim 12, wherein the surfactant is a surface active agent or a dispersant.

14. A phosphor material, comprising:
a LaPO₄:Eu⁺ phosphor material made from a LaPO₄:Eu⁺ solution;
a carbon nano-sized material added to the LaPO₄:Eu⁺ solution for mixing to obtain a mixed solution and thus to cause a precursor; and
a precipitation substance separated from the mixed solution, with the precipitation substance comprising the LaPO₄:Eu⁺ phosphor material and the carbon nano-sized material;
a LaPO₄:Eu⁺ powder material obtained from the precipitation substance by drying, grinding and sintering;
wherein the sintered LaPO₄:Eu⁺ phosphor material is coated by the CNT or carbon nanowire material for forming a reddish-orange phosphor material.

15. The phosphor material as defined in claim 14, wherein the mixed solution of the LaPO₄:Eu⁺ phosphor material has a carbon nano-sized material concentration ranging between 0.5 wt % and 0.75 wt %, 0.75 wt % and 1.0 wt %, 1.0 wt % and 1.25 wt %, or 0.5 wt % and 1.25 wt %.

16. The phosphor material as defined in claim 14, wherein the LaPO₄:Eu⁺ phosphor material has a Eu⁺ doping concentration ranging between 3.0 mole % and 5.0 mole %, 5.0 mole % and 7.0 mole %, 7.0 mole %. and 9.0 mole %, or 3.0 mole % and 9.0 mole %.

17. The phosphor material as defined in claim 14, wherein the LaPO₄:Eu⁺ phosphor material is further doped by a common dopant material.

18. The phosphor material as defined in claim 17, wherein the common dopant material is selected from the group consisting of aluminum and combination of aluminum and europium.

19. The phosphor material as defined in claim 14, wherein the LaPO₄:Eu⁺ phosphor material is further modified by a surfactant.

20. The phosphor material as defined in claim 19, wherein the surfactant is a surface active agent or a dispersant.
